(19) United States
(12) Patent Application Publication
(10) Pub. No.: US 2016/0329635 A1
(43) Pub. Date: Nov. 10, 2016

(54) ELECTRONIC DEVICE

(71) Applicant: KABUSHIKI KAISHA TOSHIBA, Tokyo (JP)

(72) Inventors: Yukako TSUTSUMI, Kawasaki Kanagawa (JP); Koji AKITA, Yokohama Kanagawa (JP)

(73) Assignee: KABUSHIKI KAISHA TOSHIBA, Tokyo (JP)

(21) Appl. No.: 15/058,959

(22) Filed: Mar. 2, 2016

(30) Foreign Application Priority Data
May 8, 2015 (JP) 2015-095837

(51) Int. Cl. H01Q 1/52

(52) U.S. Cl. CPC H01Q 1/526

(57) ABSTRACT

According to an embodiment, an electronic device includes a first board, a first ground layer, a first antenna, a second board, a second ground layer, a second antenna, a shield pipe and an electromagnetic wave absorber. When viewed from an axis direction of the shield pipe, an outermost edge of an internal wall at a first end is arranged inside an outermost edge of the first ground layer, the first antenna is arranged inside the outermost edge of the internal wall at the first end, an outermost edge of the internal wall at a second end is arranged inside an outermost edge of the second ground layer, and the second antenna is arranged inside the outermost edge of the internal wall at the second end.

### CROSS-REFERENCE TO RELATED APPLICATIONS

This application is based upon and claims the benefit of priority from Japanese Patent Application No. 2015-095837, filed May 8, 2015, the entire contents of which are incorporated herein by reference.

### FIELD

Embodiments described herein relate generally to an electronic device.

### BACKGROUND

In the prior art, a device is known in ultra-wideband (UWB) communications. The device has a structure in which a UWB communication chip set and an antenna are contained in a dedicated housing that maintains the chip set and the antenna in a state electromagnetically isolated from the periphery. In the device, the antenna is arranged inside the housing to perform UWB communications. This structure prevents the antenna from receiving spurious radiation from the peripheral devices, and increases the S/N ratio. In addition, disposing an electromagnetic wave absorber in the housing suppresses noise and multipath interference.

However, there is the problem that a complicated structure and difficult manufacturing are required to ensure an interface with the exterior in a state where the chip set and the antenna are contained in the housing, and electromagnetically isolate the inside of the housing.

### BRIEF DESCRIPTION OF THE DRAWINGS

FIG. 1A is a diagram illustrating a cross-sectional portion of a side surface of an electronic device according to a first embodiment;

FIG. 1B is a diagram of the electronic device when viewing a first board from line A-A′ illustrated in FIG. 1A;

FIG. 2 is a diagram illustrating electromagnetic waves that are reflected once;

FIG. 3 is a diagram illustrating electromagnetic waves that are reflected a plurality of times;

FIG. 4A is a diagram of a structure obtained by changing the arrangement of the electromagnetic wave absorber in FIG. 1A;

FIG. 4B is a diagram of the electronic device when viewing the first board from line A-A′ illustrated in FIG. 4A;

FIG. 4C is a diagram of a structure obtained by changing the arrangement of the electromagnetic wave absorber in FIG. 1A;

FIG. 4D is a diagram of a structure obtained by changing the arrangement of the electromagnetic wave absorber in FIG. 1A;

FIG. 4E is a diagram of the electronic device when viewing the first board from line A-A′ illustrated in FIG. 4D;

FIG. 4F is a diagram of a structure obtained by changing the shape of a shield pipe;

FIG. 4G is a diagram of a structure obtained by changing the shape of the shield pipe;

FIG. 5A is a diagram illustrating a cross-sectional portion of a side surface of an electronic device according to a second embodiment;

FIG. 5B is a diagram of the electronic device when viewing a first board from line A-A′ illustrated in FIG. 5A;

FIG. 6A is a diagram illustrating a cross-sectional portion of a side surface of an electronic device according to a third embodiment;

FIG. 6B is a diagram of the electronic device when viewing a first board from line A-A′ illustrated in FIG. 6A;

FIG. 7A is a diagram illustrating a cross-sectional portion of a side surface of an electronic device according to a fourth embodiment;

FIG. 7B is a diagram of the electronic device when viewing a first board from line A-A′ illustrated in FIG. 7A;

FIG. 8A is a diagram illustrating a cross-sectional portion of a side surface of an electronic device according to a fifth embodiment;

FIG. 8B is a diagram of the electronic device when viewing a first board from line A-A′ illustrated in FIG. 8A;

FIG. 9A is a diagram illustrating a modification of the electronic device illustrated in FIG. 8A;

FIG. 9B is a diagram of the electronic device when viewing a first board from line A-A′ illustrated in FIG. 9A;

FIG. 10A is a diagram of a structure obtained by changing the arrangement of an electromagnetic wave absorber in FIG. 8A;

FIG. 10B is a diagram of the electronic device when viewing a first board from line A-A′ illustrated in FIG. 10A;

FIG. 11A is a diagram illustrating an electromagnetic wave that is reflected once when a straight-line distance connected by a transmission antenna and a reception antenna is maximum in the electronic device illustrated in FIG. 10A; and

FIG. 11B is a diagram illustrating an electromagnetic wave that is reflected once when a straight-line distance connected by the transmission antenna and the reception antenna is minimum in the electronic device illustrated in FIG. 10A.

### DETAILED DESCRIPTION

Embodiments will be explained hereinafter with reference to the drawings.

According to an embodiment, an electronic device includes a first board, a first ground layer, a first antenna, a second board, a second ground layer, a second antenna, a shield pipe and an electromagnetic wave absorber. The first board has a first surface and a second surface opposed to the first surface, the first board having a first internal layer. The first ground layer formed on at least one of the first surface and the first internal layer. The first antenna arranged on at least one of the second surface and a region between the first ground layer and the second surface. The second board has a third surface and a fourth surface opposed to the third surface, the second board having a second internal layer, the fourth surface opposed to the second surface. The second ground layer formed on at least one of the third surface and the second internal layer. The second antenna arranged on at least one of the fourth surface and a region between the second ground layer and the fourth surface. The shield pipe arranged between the first board and the second board and formed of a conductor including a first end, a second end, and an internal wall, the first end opposed to the second surface, the second end opposed to the fourth surface. The electromagnetic wave absorber arranged on the internal wall. When viewed from an axis direction of the shield pipe, an outermost edge of the internal wall at the first end is arranged inside an outermost edge of the first ground layer, the first antenna is arranged inside the outermost edge of the internal wall at the first end, an outermost edge of the internal wall at the second end is arranged inside an outermost edge of the second ground layer, and the second antenna is arranged inside the outermost edge of the internal wall at the second end.

In the following explanation, constituent elements that are the same as or similar to the explained will be denoted by the same or similar reference numerals, and overlapping explanation thereof will be basically omitted.

Although the following explanation illustrates that a transmission antenna, a reception antenna, a wireless transmitting unit and a wireless receiving unit are independent of each other, the transmission antenna may have the function of the reception antenna, the reception antenna may have the function of the transmission antenna, the wireless transmitting unit may have the function of the wireless receiving unit, or the wireless receiving unit may have the function of the wireless transmitting unit. In other words, the antenna may have a transmitting/receiving function alone, or the wireless unit may perform signal processing related to transmission and reception alone.

### First Embodiment

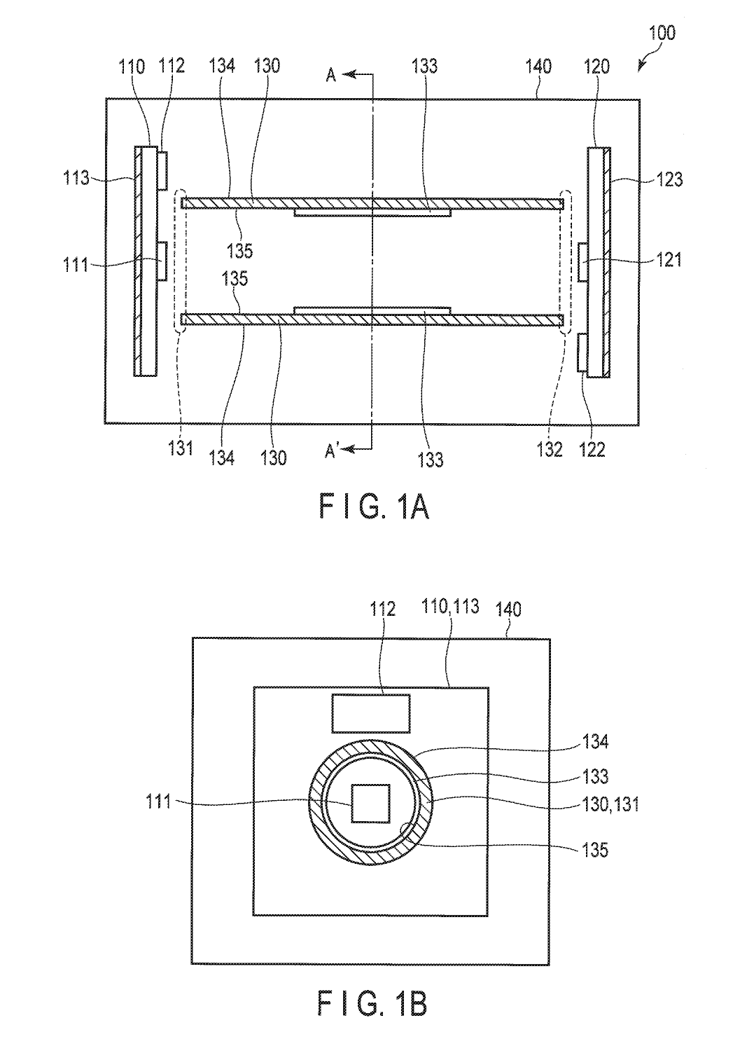

FIG. 1A illustrates a cross-sectional portion of a side surface of an electronic device 100 according to a first embodiment. The electronic device 100 includes a first board 110, a first transmission antenna 111 (also referred to as “first antenna”), a first wireless transmitting unit 112 (also referred to as “first wireless unit”), a first ground layer 113, a second board 120, a first reception antenna 121 (also referred to as “second antenna”), a first wireless receiving unit 122 (also referred to as “second wireless unit”), a second ground layer 123, a shield pipe 130, and a housing 140. The first board 110 and the second board 120 are arranged to face each other. The shield pipe 130 is arranged between the first board 110 and the second board 120. The housing 140 contains the first board 110, the second board 120, and the shield pipe 130.

The first board 110 includes a first surface and a second surface opposed to the first surface. The first ground layer 113 is formed on at least one of the first surface of the first board 110 and an internal layer of the first board 110. The first transmission antenna 111 is arranged on at least one of the second surface of the first board 110 and between the first ground layer 113 and the second surface of the first board 110. For example, the first transmission antenna 111 is arranged in the internal layer of the first board 110, in the case where a solder resist is applied onto the antenna surface. The first wireless transmitting unit 112 is arranged on the second surface of the first board 110. FIG. 1A illustrates the example where the first wireless transmitting unit 112 is arranged on the first board 110, but the first wireless transmitting unit 112 may be arranged in an internal layer of the first board 110, or may be arranged outside the first board 110.

The first transmission antenna 111 is electrically connected with the first wireless transmitting unit 112. The first wireless transmitting unit 112 communicates with the first wireless receiving unit 122 described later, and performs signal processing.

The first ground layer 113 is formed of a conductor. The first ground layer 113 is not required to be a conductor over all the surface thereof, but may have a hole or a crack. Part of the first ground layer 113 may be provided with a signal line or a power supply.

The second board 120 includes a first surface (also referred to as “third surface”) and a second surface (also referred to as “fourth surface”) opposed to the first surface. The second ground layer 123 is formed on at least one of the first surface of the second board 120 and an internal layer of the second board 120. The first reception antenna 121 is arranged on at least one of the second surface of the second board 120 and a region between the second ground layer 123 and the second surface of the second board 120. For example, the first reception antenna 121 is arranged in the internal layer of the second board 120, in the case where a solder resist is applied onto the antenna surface. The first wireless receiving unit 122 is arranged on the second surface of the second board 120. The first wireless receiving unit 122 may be arranged in an internal layer of the second board 120, or may be arranged outside the second board 120, in the same manner as the first wireless transmitting unit 112.

The first reception antenna 121 is electrically connected with the first wireless receiving unit 122. The first wireless receiving unit 122 communicates with the first wireless transmitting unit 112, and performs signal processing.

The second ground layer 123 is formed of a conductor. The second ground layer 123 is not required to be a conductor over all the surface thereof, but may have a hole or a crack. Part of the second ground layer 123 may be provided with a signal line or a power supply.

The shield pipe 130 is a pipe that is formed of a conductor including a first end 131, a second end 132, an external wall 134, and an internal wall 135. The first end 131 is opened and opposed to the second surface of the first board 110. The second end 132 is opened and opposed to the second surface of the second board 120. Otherwise, the shield pipe 130 may be formed of a non-conductor (such as resin) having a metal-plated surface.

In the following explanation, these elements are collectively described as “conductor”. The conductor forming the shield pipe 130 may be electrically connected with at least one of the first ground layer 113 and the second ground layer 123, to prevent reradiation from a current induced by the conductor.

The present embodiment illustrates the example where the shield pipe 130 is formed of a hollow circular cylinder. Otherwise, the shield pipe 130 may be formed of a hollow quadratic prism, a hollow circular truncated cone, or a hollow truncated pyramid.

The shield pipe 130 cuts off electromagnetic waves from the outside different from the electronic device 100, to suppress interference with the electromagnetic waves.

The first end 131 is arranged to be opposed to the second surface of the first board 110. For example, the length of the longest line segment connecting two different points of the edge of the internal wall 135 at the first end 131 is equal to or longer than the wavelength of the central frequency in the frequency band used for communication via the first transmission antenna 111 and the first reception antenna 121.

A space may be provided between the first end 131 and the first ground layer 113. The space is a distance between the conductors, and may be filled with an insulator such as a dielectric. For example, the space (that is, a distance between the first end 131 and the first ground layer 113) is required to be smaller than the wavelength of the central frequency in the frequency band used for communication via the first transmission antenna 111 and the first reception antenna 121.

The second end 132 is arranged to be opposed to the second surface of the second board 120. For example, the length of the longest line segment connecting two different points of the edge of the internal wall 135 at the second end 132 is equal to or longer than the wavelength of the central frequency in the frequency band used for communication via the first transmission antenna 111 and the first reception antenna 121.

A space may be provided between the second end 132 and the second ground layer 123. The space is a distance between the conductors, and may be filled with an insulator such as a dielectric. For example, the space (that is, a distance between the second end 132 and the second ground layer 123) is required to be smaller than the wavelength of the central frequency in the frequency band used for communication via the first transmission antenna 111 and the first reception antenna 121.

Generally, because an antenna formed on the board has a size of the wavelength order, the antenna may be easily arranged inside an outermost edge of the internal wall 135 at the first end 131 or the second end 132 by setting the size of opening portions of the first end 131 and the second end 132 to be equal to or larger than the wavelength used for communication.

By setting the space to be shorter than the wavelength of the central frequency in the frequency band used for communication via the first transmission antenna 111 and the second reception antenna 121, electromagnetic waves are prevented from leaking to the outside of the shield pipe, and electromagnetic waves are prevented from entering the inside of the shield pipe.

An electromagnetic wave absorber 133 is an object formed of a material that suppresses reflection of electromagnetic waves, and arranged on at least part of the internal wall 135 of the shield pipe 130. For example, the electromagnetic wave absorber 133 is arranged on the internal wall 135 of the shield pipe 130 and in a region including a midpoint between the first end 131 and the second end 132. The electromagnetic wave absorber 133 efficiently suppresses electromagnetic waves which radiated from the first transmission antenna 111 and reflected at the internal wall 135 of the shield pipe 130, and suppresses multipath interference. Other arrangements of the electromagnetic wave absorber 133 will be described later.

The footprint of the electromagnetic wave absorber 133 in the shield pipe 130 can be reduced by enclosing electromagnetic waves radiated from the first transmission antenna 111 inside the shield pipe 130. When the electromagnetic waves radiated from the first transmission antenna 111 are not enclosed inside the shield pipe 130, the electromagnetic wave absorber 133 is required to be arranged inside the housing 140 widely, and the footprint of the electromagnetic wave absorber 133 is increased. For this reason, because the shield pipe 130 efficiently suppresses reflected waves with the smaller electromagnetic wave absorber 133, the cost of the electromagnetic wave absorber 133 can be reduced.

FIG. 1B is a diagram of the electronic device 100 when viewing the first board 110 from line A-A′ illustrated in FIG. 1A. When viewing the first board 110 from the axis direction of the shield pipe 130, the outermost edge of the internal wall 135 at the first end 131 is arranged inside the outermost edge of the first ground layer 113, and the first transmission antenna 111 is arranged inside the outermost edge of the internal wall 135 at the first end 131.

The second board 120 side has a similar structure. When viewing the second board 120 from the axis direction of the shield pipe 130, the outermost edge of the internal wall 135 at the second end 132 is arranged inside the outermost edge of the second ground layer 123, and the first reception antenna 121 is arranged inside the outermost edge of the internal wall 135 at the second end 132. In the following explanation, “when viewing the first board 110 (or the second board 120) from the axis direction of the shield pipe 130” is simply referred to as “as viewed from the cross section”, in similar drawings when viewing the first board 110 (or the second board 120) from line A-A′.

The space surrounded by the internal wall 135 of the shield pipe 130, the electromagnetic wave absorber 133, the first ground layer 113 and the second ground layer 123 includes a first Fresnel zone formed by communication via the first transmission antenna 111 and the first reception antenna 121. The first Fresnel zone is a space indicated by a spheroid formed of an aggregate of paths from transmission antenna to reception antenna. Each of differences in length between each of the paths and the direct path from the transmission antenna to the reception antenna is equal to or less than half of the wavelength of the frequency used for communication. When any obstacle exists in the spheroid, loss may occur due to blocking. For this reason, the space surrounded by the internal wall 135 of the shield pipe 130, the electromagnetic wave absorber 133, the first ground layer 113 and the second ground layer 123 includes the first Fresnel zone, to prevent loss caused by blocking.

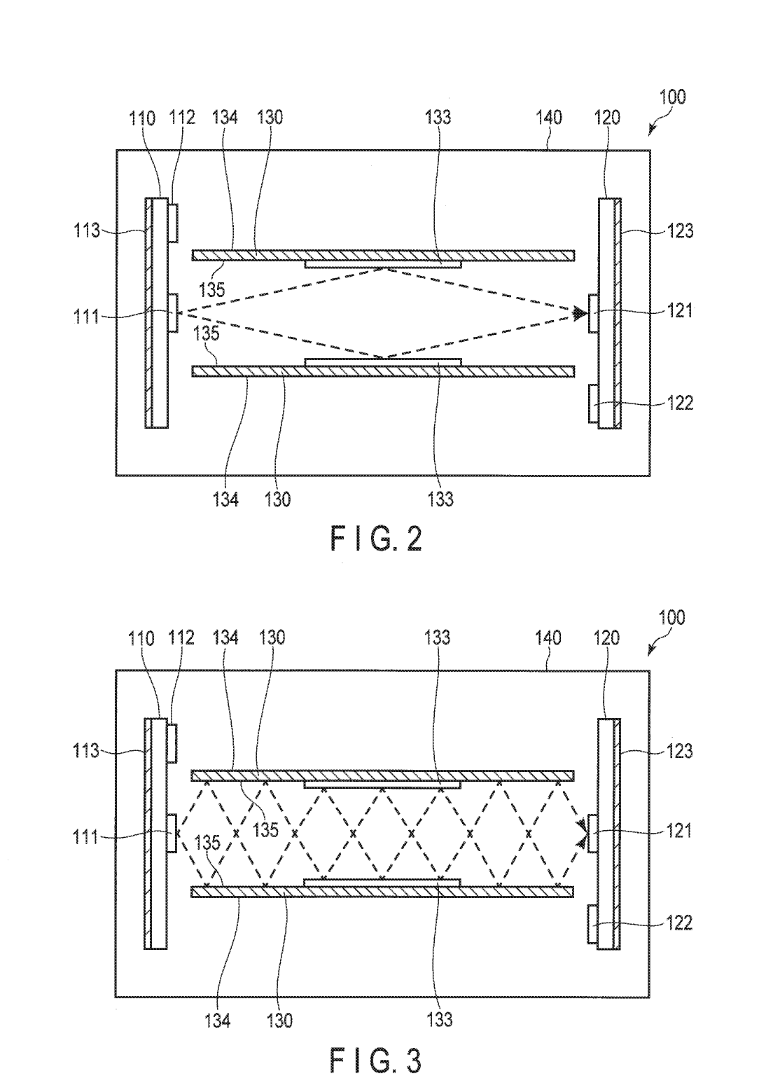

As illustrated in FIG. 1A, for example, the electromagnetic wave absorber 133 is arranged on the internal wall 135 of the shield pipe 130 and in a region including the midpoint between the first end 131 and the second end 132. FIG. 2 and FIG. 3 illustrate reflected waves in the case of adopting the arrangement.

FIG. 2 illustrates the state where electromagnetic waves (thick-line arrows in FIG. 2) radiated from the first transmission antenna 111 are reflected once by the internal wall 135 of the shield pipe 130 and received on the first reception antenna 121. Because the electromagnetic wave absorber 133 is arranged in a portion where the electromagnetic waves radiated from the first transmission antenna 111 are reflected by the internal wall 135 of the shield pipe 130, the intensity of the electromagnetic waves when the electromagnetic waves are made incident on the first reception antenna 121 is suppressed.

As illustrated in FIG. 2, an angle (referred to as “radiation angle”) between the direction of the electromagnetic wave reflected once by the internal wall 135 of the shield pipe 130 and the direction perpendicular to the surface of the first board 110 is small. In the same manner, an angle (referred to as “incident angle”) between the direction in which the electromagnetic wave is made incident on the first reception antenna 121 and the direction perpendicular to the surface of the second board 120 is small. If the antenna directivity increases as the incident angle becomes smaller, this structure suppresses reflected waves of large power, and thus is effective for suppression of multipath interference.

FIG. 3 illustrates the state where electromagnetic waves (thick-line arrows in FIG. 3) radiated from the first transmission antenna 111 are reflected a plurality of times by the internal wall 135 of the shield pipe 130 and received on the first reception antenna 121. Because the electromagnetic wave absorber 133 is arranged in a portion where the electromagnetic waves are reflected for the third time to the fifth time by the internal wall 135 of the shield pipe 130, the intensity of the reflected waves when the reflected waves are made incident on the first reception antenna 121 is suppressed.

The electromagnetic wave absorber 133 is arranged on the internal wall 135 of the shield pipe 130 and in a region including a midpoint between the first end 131 and the second end 132. This arrangement suppresses electromagnetic waves reflected once by the internal wall 135 of the shield pipe 130 as illustrated in FIG. 2, and electromagnetic waves reflected a plurality of times by the internal wall 135 of the shield pipe 130 as illustrated in FIG. 3, and is effective for suppression of multipath interference.

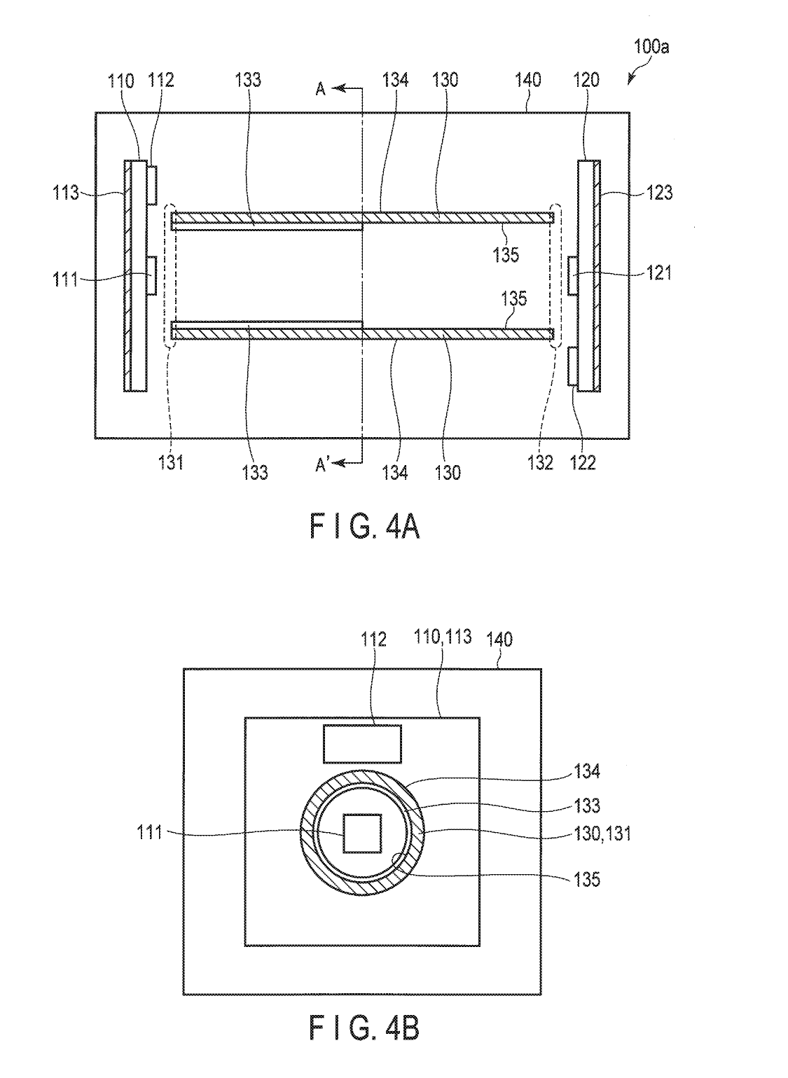

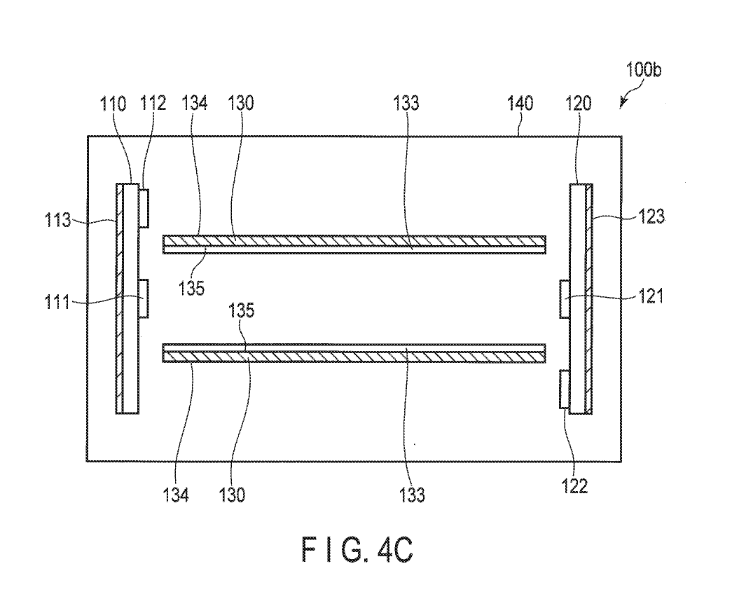

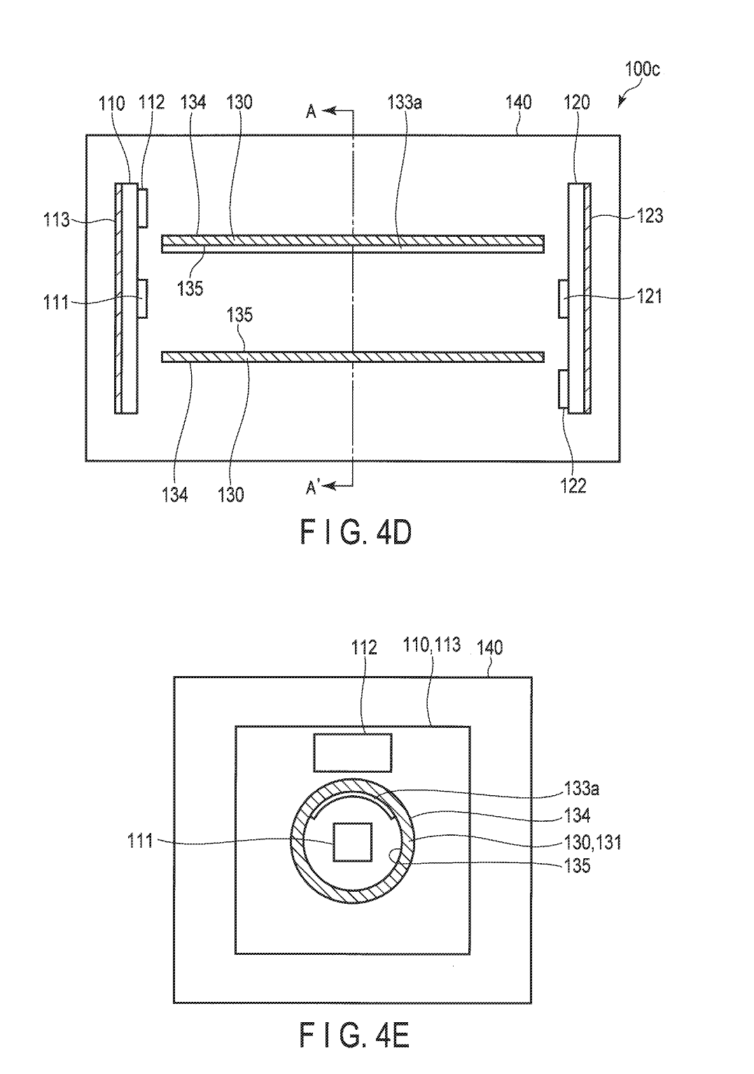

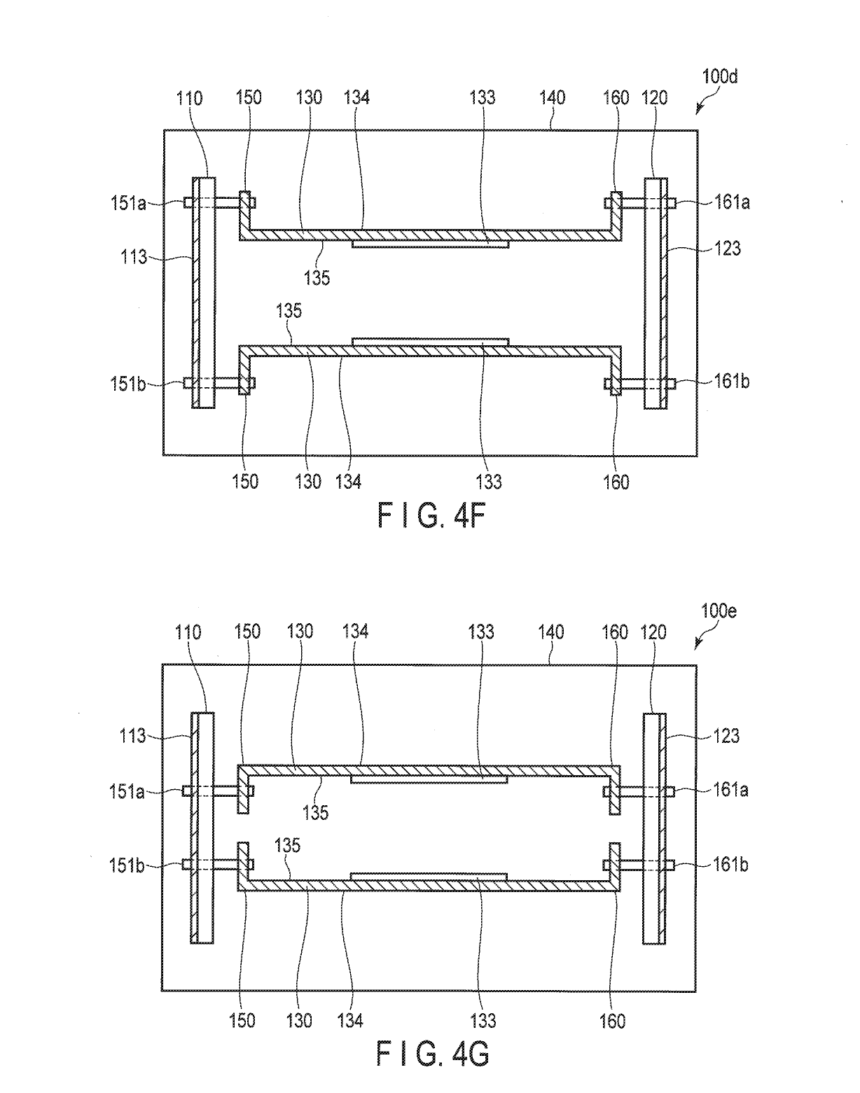

FIG. 4A illustrates an electronic device 100a corresponding to a modification of the electronic device 100. The electronic device 100a is different from the electronic device 100 in the arrangement of the electromagnetic wave absorber 133. The electromagnetic wave absorber 133 is arranged on a region of the internal wall 135 of the shield pipe 130, and in the region covering from the first end 131 to the midpoint between the first end 131 and the second end 132. The electronic device 100a also suppresses reflection of electromagnetic waves by the internal wall 135 of the shield pipe 130, in the same manner as the electronic device 100. FIG. 4B illustrates an external appearance similar to that of FIG. 1A, and explanation thereof is omitted.

FIG. 4C illustrates an electronic device 100b corresponding to a modification of the electronic device 100. The electronic device 100b is different from the electronic device 100 in the arrangement of the electromagnetic wave absorber 133. The electromagnetic wave absorber 133 is arranged on the internal wall 135 of the shield pipe 130, and covers from the first end 131 to the second end 132. In other words, the electromagnetic wave absorber 133 is arranged in all the regions of the internal wall 135 of the shield pipe 130. The electronic device 100b also suppresses reflection of electromagnetic waves by the internal wall 135 of the shield pipe 130.

The electromagnetic wave absorber 133 may be arranged on the internal wall 135 of the shield pipe 130, and in a region located in an extending direction of the shield pipe 130 and including a region of the internal wall 135 of the shield pipe 130 that is close to the first transmission antenna 111. For example, as illustrated in FIG. 4D and FIG. 4E, an electromagnetic wave absorber 133a is arranged in an arc shape to extend from the first end 131 to the second end 132.

FIG. 4F illustrates an electronic device 100d corresponding to a modification of the electronic device 100. The electronic device 100d is different from the electronic device 100 in that the first end 131 and the second end 132 are provided with a first flange 150 and a second flange 160 to extend outward, respectively. FIG. 4F omits illustration of the first transmission antenna 111, the first wireless transmitting unit 112, the first reception antenna 121, and the first wireless receiving unit 122.

The first flange 150 is used for fixing the shield pipe 130 to the first board 110 with screws 151a and 151b. The second flange 160 is used for fixing the shield pipe 130 to the second board 120 with screws 161a and 161b. The flanges may be fixed to one of the first board 110 and the second board 120. The above screws are not limited to two, but may be one or three or more screws.

FIG. 4G illustrates an electronic device 100e corresponding to a modification of the electronic device 100. The electronic device 100e is different from the electronic device 100 in that the first end 131 and the second end 132 are provided with a first flange 150 and a second flange 160 to extend inward, respectively. FIG. 4G omits illustration of the first transmission antenna 111, the first wireless transmitting unit 112, the first reception antenna 121, and the first wireless receiving unit 122. Explanations of the flanges and the screws are omitted, because they are similar to those of the electronic device 100d.

As described above, the electronic device according to the first embodiment prevents noise occurring outside from entering the shield pipe, with the first ground layer of the first board, the second ground layer of the second board, and the shield pipe. The electronic device also suppresses interference caused by reflection of electromagnetic waves radiated from the antenna arranged on the board, by disposing the electromagnetic wave absorber on the internal wall of the shield pipe. Accordingly, the electronic device enables suppression of interference of electromagnetic waves with a simple structure.

The frequency used for communication between the antennas may be, for example, a frequency of a millimeter wave band. Because the millimeter wave band has a short wavelength of several millimeters, the sizes of the antennas and the shield pipes can be reduced. In addition, the modulation method of the wireless system may be, for example, amplitude shift keying. This modulation method achieves a simple structure and low power consumption, but easily incurs interference of electromagnetic waves. However, using the electronic device according to the first embodiment suppresses interference of electromagnetic waves.

### Second Embodiment

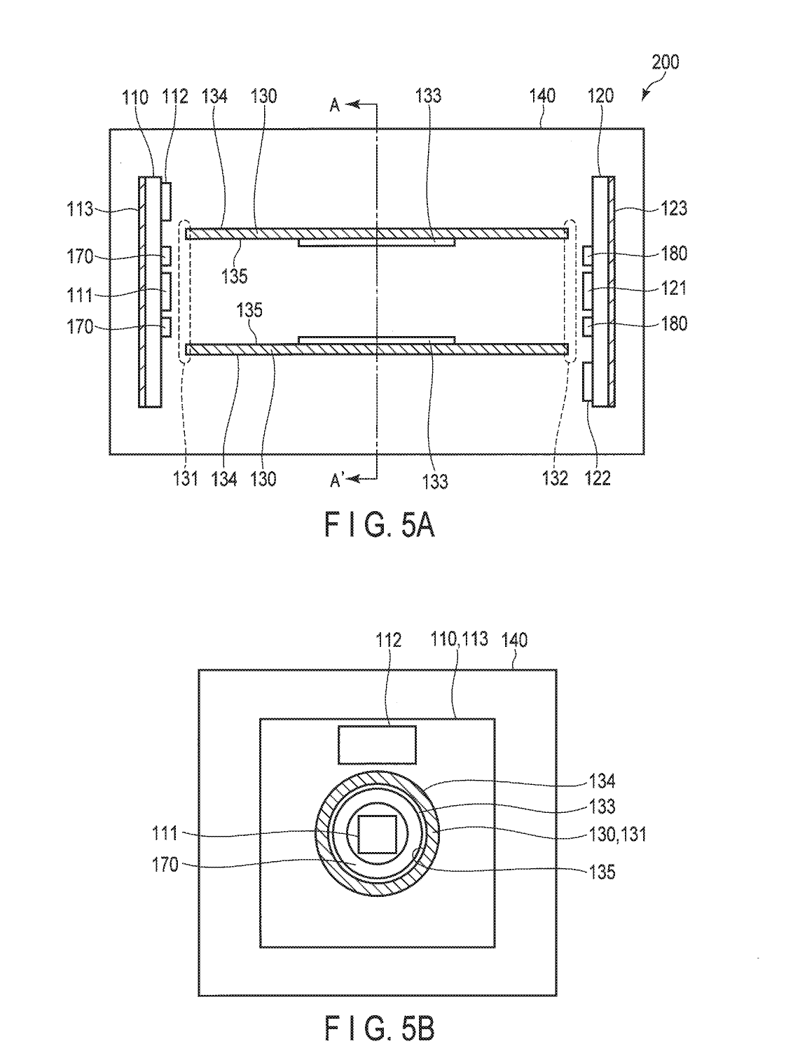

FIG. 5A illustrates a cross-sectional portion of a side surface of an electronic device 200 according to a second embodiment. The electronic device 200 has a structure obtained by adding other electromagnetic wave absorbers to the electronic device explained in the above first embodiment. Specifically, the electronic device 200 has a structure in which an electromagnetic wave absorber 170 and an electromagnetic wave absorber 180 are arranged on a first board 110 and a second board 120, respectively.

As illustrated in FIG. 5B, the electromagnetic wave absorber 170 is arranged on the first board 110 to surround the first transmission antenna 111. Specifically, as viewed from the cross section, the outermost edge of the electromagnetic wave absorber 170 is arranged inside the internal wall 135 of the outermost edge at the first end 131, and the electromagnetic wave absorber 170 is arranged in a position different from the first transmission antenna 111.

The second board side also has a similar structure for the first board. The electromagnetic wave absorber 180 is arranged on the second board 120 to surround the first reception antenna 121. Specifically, as viewed from the cross section, the outermost edge of the electromagnetic wave absorber 180 is arranged inside the internal wall 135 of the outermost edge at the second end 132, and the electromagnetic wave absorber 180 is arranged in a position different from the first reception antenna 121.

It suffices that the electronic device 200 is provided with at least one of the electromagnetic wave absorber 170 and the electromagnetic wave absorber 180. The electromagnetic wave absorber 170 and the electromagnetic wave absorber 180 may be arranged to extend over all the regions except the antennas. The electromagnetic wave absorber 170 and the electromagnetic wave absorber 180 are not limited to the shape of surrounding the antenna, but part of them may be arranged on the board, or a plurality of them may be arranged on the board.

As described above, the electronic device according to the second embodiment suppresses reflection of electromagnetic waves by the boards, by disposing the electromagnetic wave absorbers also around the antennas. Accordingly, the electronic device further suppresses interference of electromagnetic waves due to multipath propagation.

### Third Embodiment

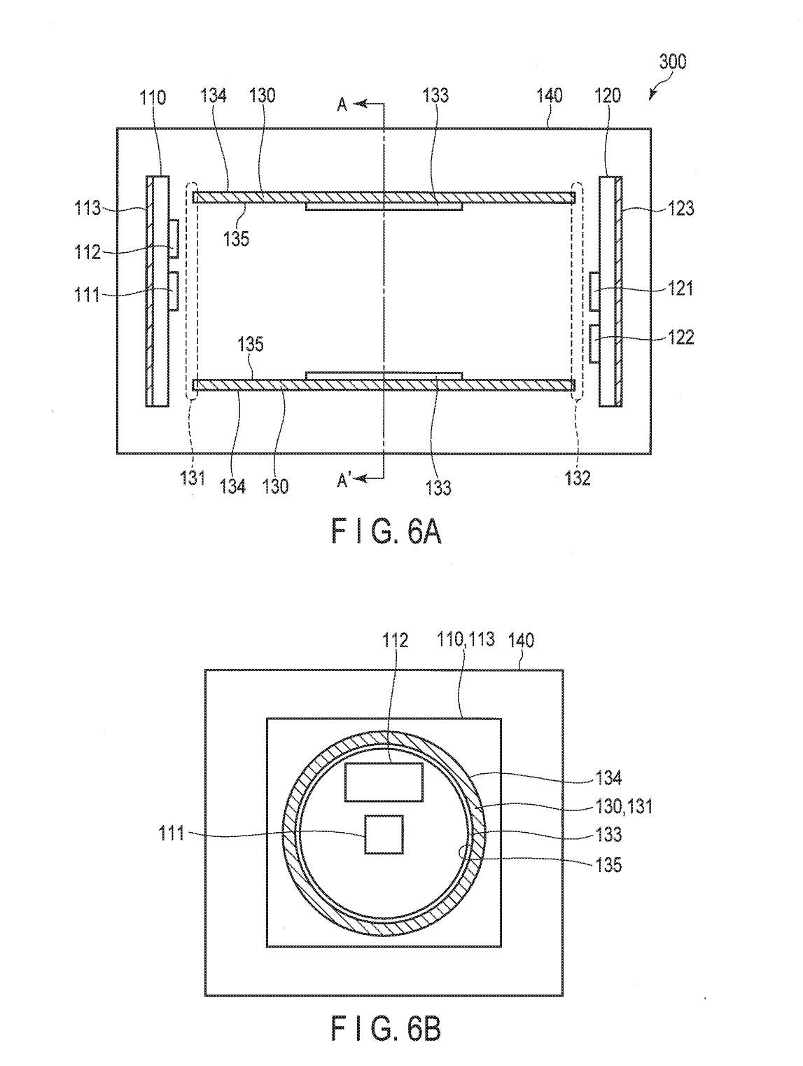

FIG. 6A illustrates a cross-sectional portion of a side surface of an electronic device 300 according to a third embodiment. The electronic device 300 is different from the electronic devices of the first embodiment and the second embodiment described above in the arrangement of the first wireless transmitting unit 112 and the first wireless receiving unit 122.

As illustrated in FIG. 6B, as viewed in a direction perpendicular to the surface of the board, the first transmission antenna 111 and the first wireless transmitting unit 112 are arranged inside the outermost edge of the internal wall 135 at the first end 131. The second board also has a similar structure, in which the first reception antenna 121 and the first wireless receiving unit 122 are arranged inside the outermost edge of the internal wall 135 at the second end 132.

As described above, the electronic device according to the third embodiment suppresses discharge of noise generated from the wireless transmitting unit and the wireless receiving unit to the outside of the region surrounded by the first ground layer of the first board, the second ground layer of the second board, and the shield pipe. The electronic device also suppresses influence of noise from the outside of the region surrounded by the first ground layer of the first board, the second ground layer of the second board, and the shield pipe.

### Fourth Embodiment

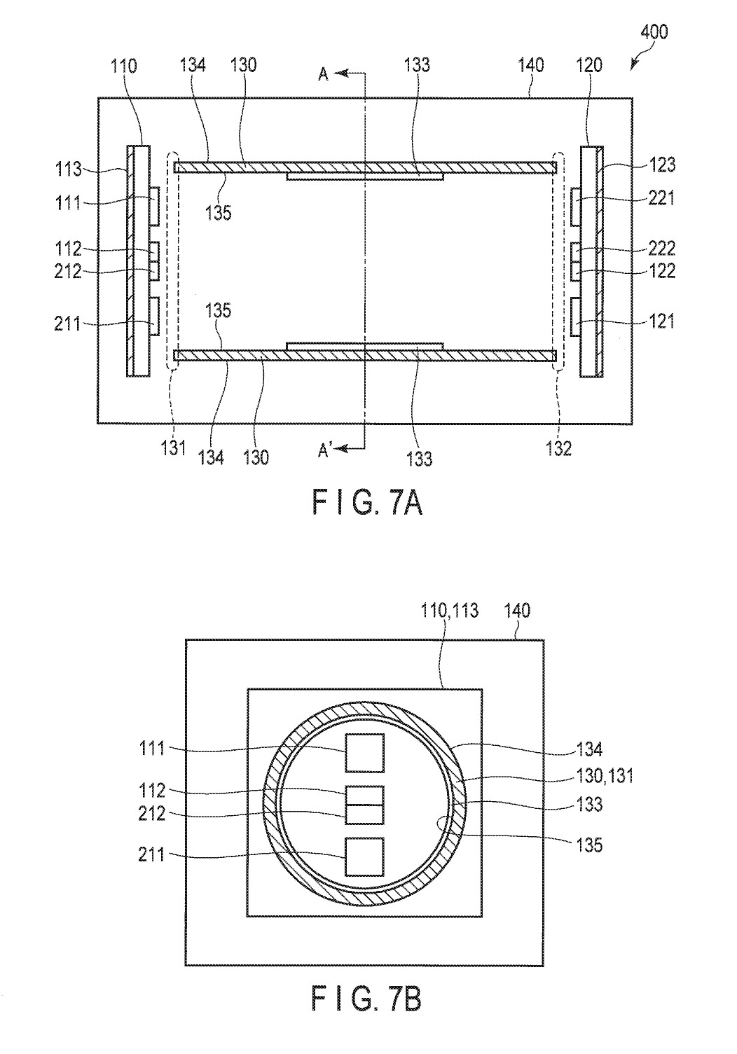

FIG. 7A illustrates a cross-sectional portion of a side surface of an electronic device 400 according to a fourth embodiment. The electronic device 400 is different from the electronic devices of the first embodiment, the second embodiment, and the third embodiment described above, in that the electronic device 400 further includes a second reception antenna 211 (also referred to as “third antenna”), a second wireless receiving unit 212 (also referred to as “third wireless unit”), a second transmission antenna 221 (also referred to as “fourth antenna”), and a second wireless transmission unit 222 (also referred to as “fourth wireless unit”). For example, the second reception antenna 211 and the second transmission antenna 221 are used for communication using a frequency band that is different from the frequency band used for communication via the first transmission antenna 111 and the first reception antenna 121 described above.

The second reception antenna 211 is arranged on at least one of the second surface of the first board 110, and a region between the first ground layer 113 and the second surface of the first board 110. The second wireless receiving unit 212 is arranged on the second surface of the first board 110.

The second reception antenna 211 is electrically connected with the second wireless receiving unit 212. The second wireless receiving unit 212 communicates with the second wireless transmitting unit 222 described later, and performs signal processing.

The second transmission antenna 221 is arranged on at least one of the second surface of the second board 220, and a region between the second ground layer 123 and the second surface of the second board 120. The second wireless transmitting unit 222 is arranged on the second surface of the second board 120.

The second transmission antenna 221 is electrically connected with the second wireless transmitting unit 222. The second wireless transmitting unit 222 communicates with the second wireless receiving unit 212, and performs signal processing.

The second reception antenna 211, the second wireless receiving unit 212, the second transmission antenna 221, and the second wireless transmitting unit 222 may be arranged in the same manner as the first transmission antenna 111, the first wireless transmission unit 112, the first reception antenna 121, and the first wireless receiving unit 122 in the first embodiment, respectively.

As illustrated in FIG. 7B, as viewed in a direction perpendicular to the surface of the board, the second reception antenna 211 and the second wireless receiving unit 212 are arranged inside the outermost edge of the internal wall 135 at the first end 131. The electronic device 400 also has a similar structure on the second board, in which the second transmission antenna 221 and the second wireless transmitting unit 222 are arranged inside the outermost edge of the internal wall 135 at the second end 132.

The space surrounded by the internal wall 135 of the shield pipe 130, the electromagnetic wave absorber 133, the first ground layer 113 and the second ground layer 123 includes a first Fresnel zone formed by communication via the second reception antenna 211 and the second transmission antenna 221.

As described above, the electronic device according to the fourth embodiment further includes the second transmission antenna, the second wireless transmitting unit, the second reception antenna, and the second wireless receiving unit, and thereby suppresses interference of electromagnetic waves due to multipath propagation, while performing bidirectional communication with each other using frequency division duplex.

### Fifth Embodiment

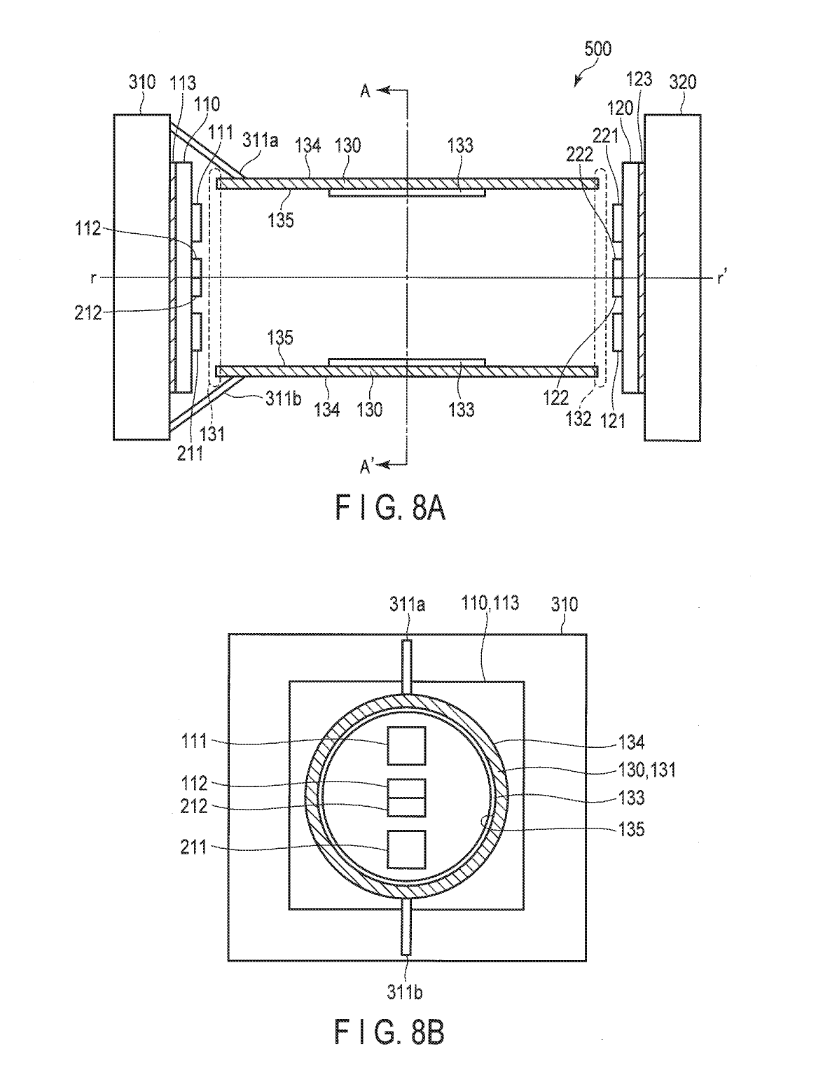

FIG. 8A illustrates a cross-sectional portion of a side surface of an electronic device 500 according to a fifth embodiment. The electronic device 500 is different from the electronic device of the fourth embodiment described above in that the electronic device 500 further includes a rotary part 310, shield pipe fixing portions 311a and 311b, and a fixed part 320. FIG. 8A omits illustration of the housing 140.

A first board 110 is arranged on the rotary part 310. A shield pipe 130 is fixed to the rotary part 310 via the shield pipe fixing portions 311a and 311b. The rotary part 310 is relatively rotatable with respect to a second board 120, with a rotation axis r-r′ illustrated in FIG. 8A. The second board 120 is arranged on a surface of the fixed part 320 opposed to the rotary part 310.

A gap exists between the second end 132 of the shield pipe 130 and the second board 120, because the rotary part 310 is rotated together with the shield pipe 130. In the case where the second end 132 of the shield pipe 130 contacts the second board 120, it is desirable to reduce the friction. The distance between the second end 132 of the shield pipe 130 and the second ground layer 123 of the second board 120 should be smaller than the wavelength of the central frequency in the frequency band used for communication via the first transmission antenna 111 and the first reception antenna 121.

As illustrated in FIG. 8B, the shield pipe fixing portions 311a and 311b fix the rotary part 310 and the shield pipe 130. The shield pipe fixing portions are not limited to two, but may be one, or three or more.

Although the shield pipe fixing portions 311a and 311b fix the rotary part 310 and the shield pipe 130 in FIG. 8A and FIG. 8B, the shield pipe 130 may be fixed to the first board 110 using a flange and screws, in the same manner as the examples illustrated in FIG. 4F and FIG. 4G.

The shield pipe 130 may be fixed to the fixed part 320, unlike the example illustrated in FIG. 8A and FIG. 8B. In such a case, the shield pipe 130 is not rotated together with the rotary part 310.

The electronic device 500 has a structure in which a relative angle of the first reception antenna 121 with respect to the first transmission antenna 111 is changed by rotation of the rotary part 310. In such a case, circularly polarized wave antennas are used as the first transmission antenna 111 and the first reception antenna 121. This structure suppresses deterioration in communication due to polarized wave mismatch. The same is applicable to the second reception antenna 211 and the second transmission antenna 221.

To form polarized wave diversity in the case of using circularly polarized wave antennas, the first transmission antenna 111 and the first reception antenna 121 should be set to have the same turning direction of the circularly polarized waves, the second reception antenna 211 and the second transmission antenna 221 should be set to have the same turning direction of the circularly polarized waves, and the first transmission antenna 111 and the second transmission antenna 221 should be set to have opposite turning directions. These settings suppress interference between communication between the first transmission antenna 111 and the first reception antenna 121 and communication between the second reception antenna 211 and the second transmission antenna 221.

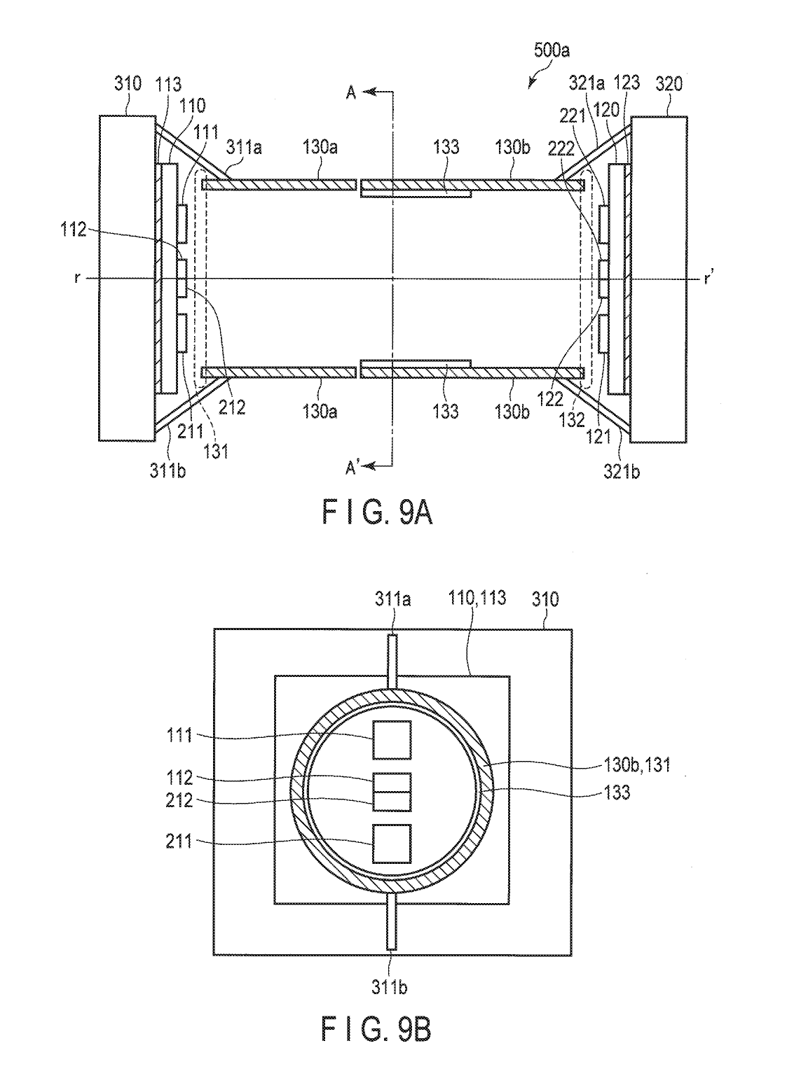

FIG. 9A illustrates an electronic device 500a corresponding to a modification of the electronic device 500. The electronic device 500a is different from the electronic device 500 in that the shield pipe 130 is divided into a shield pipe 130a including a first end 131, and a shield pipe 130b including a second end 132, and the electronic device 500a further includes shield pipe fixing portions 321a and 321b.

FIG. 9A omits illustration of the housing 140.

The rotary part 310 and the shield pipe 130a are fixed to each other via the shield pipe fixing portions 311a and 311b. The fixed part 320 and the shield pipe 130b are fixed to each other via the shield pipe fixing portions 321a and 321b.

Although FIG. 9A illustrates that the shield pipe fixing portions 311a and 311b fix the rotary part 310 and the shield pipe 130a and the shield pipe fixing portions 321a and 321b fix the fixed part 320 and the shield pipe 130b, they may be fixed using flanges and screws in the same manner as the examples illustrated in FIG. 4F and FIG. 4G.

A gap exists between the shield pipe 130a and the shield pipe 130b, because the rotary part 310 is relatively rotated together with the shield pipe 130a with respect to the shield pipe 130b. In the case where the shield pipe 130a contacts the shield pipe 130b, it is desirable to reduce the friction in contact. The distance between the shield pipe 130a and the shield pipe 130b should be smaller than the wavelength of the central frequency in the frequency band used for communication via the first transmission antenna 111 and the first reception antenna 121.

FIG. 9B illustrates an external appearance similar to that of FIG. 8B, and explanation thereof is omitted.

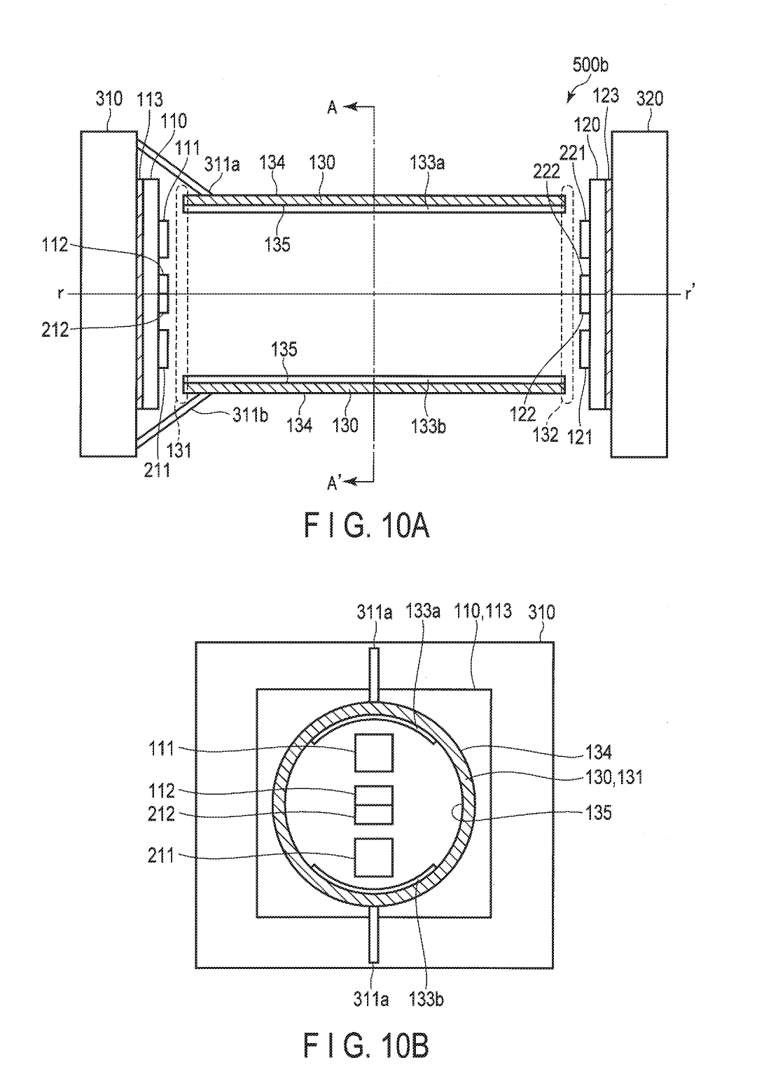

FIG. 10A illustrates an electronic device 500b corresponding to a modification of the electronic device 500. The electronic device 500b is different from the electronic device 500 in the arrangement of the electromagnetic wave absorber 133. FIG. 10A omits illustration of the housing 140.

An electromagnetic wave absorber 133a and an electromagnetic wave absorber 133b are arranged on the internal wall 135 of the shield pipe 130. Specifically, as illustrated in FIG. 10A and FIG. 10B, the electromagnetic wave absorber 133a is arranged in a first region located in an extending direction of the shield pipe 130 and including a region of the internal wall 135 of the shield pipe 130 that is close to the first transmission antenna 111. The electromagnetic wave absorber 133b is arranged in a second region located in the extending direction of the shield pipe 130 and including a region of the internal wall 135 of the shield pipe 130 that is close to the second reception antenna 211. In the example illustrated in FIG. 10A and FIG. 10B, each of the electromagnetic wave absorber 133a and the electromagnetic wave absorber 133b is formed in an arc shape to extend from the first end 131 to the second end 132 of the shield pipe 130.

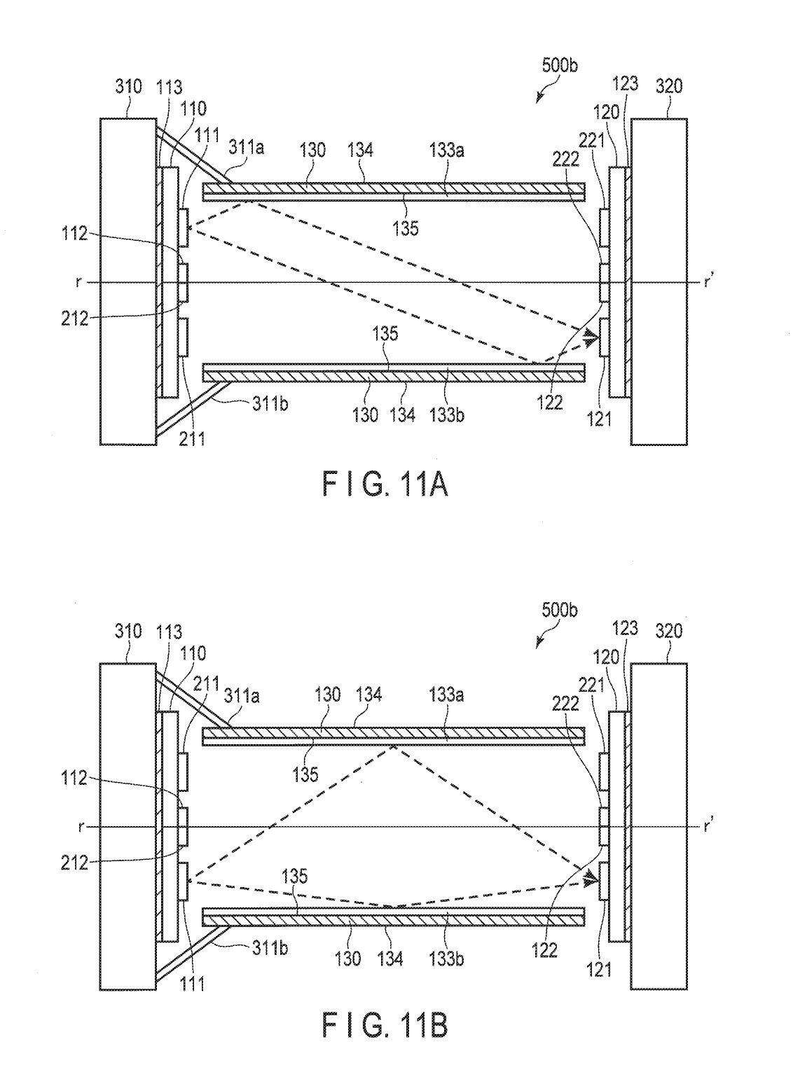

FIG. 11A illustrates a state where a distance of a straight line between the first transmission antenna 111 and the first reception antenna 121 is longest. FIG. 11A illustrates reflected waves radiated from the first transmission antenna 111, reflected only once by the internal wall 135 of the shield pipe 130, and received on the first reception antenna 121. The intensity of electromagnetic waves radiated from the first transmission antenna 111 and reflected only once by the internal wall 135 of the shield pipe 130 is suppressed when they are made incident on the first reception antenna 121, because the electromagnetic wave absorber 133a and the electromagnetic wave absorber 133b are arranged on portions of the internal wall 135 of the shield pipe 130 where the electromagnetic waves are reflected.

FIG. 11B illustrates a state where a distance of a straight line between the first transmission antenna 111 and the first reception antenna 121 is shortest. FIG. 11B illustrates reflected waves radiated from the first transmission antenna 111, reflected only once by the internal wall 135 of the shield pipe 130, and received on the first reception antenna 121. The intensity of electromagnetic waves radiated from the first transmission antenna 111 and reflected only once by the internal wall 135 of the shield pipe 130 is suppressed when they are made incident on the first reception antenna 121, because the electromagnetic wave absorber 133a and the electromagnetic wave absorber 133b are arranged on portions of the internal wall 135 of the shield pipe 130 where the electromagnetic waves are reflected. FIG. 11B is a diagram in the case where the rotary part 310 of FIG. 11A is rotated by 180° around the rotation axis r-r′ with respect to the fixed part 320.

As illustrated in FIG. 11A and FIG. 11B, in reflected waves radiated from the first transmission antenna 111, reflected only once by the internal wall 135 of the shield pipe 130, and received on the first reception antenna 121, the radiation angle or the incident angle of an electromagnetic wave reflected in a region of the internal wall 135 of the shield pipe 130 close to the antenna is relatively small. When it is specifically explained with reference to FIG. 11B, the radiation angle and the incident angle of an electromagnetic wave radiated from the first transmission antenna 111 toward the electromagnetic wave absorber 133b, reflected only once by the internal wall 135 of the shield pipe 130, and received on the first reception antenna 121 is smaller than the incident angle and the radiation angle of an electromagnetic wave radiated toward the electromagnetic wave absorber 133a, reflected only once by the internal wall 135 of the shield pipe 130, and received on the first reception antenna 121.

If the antenna directivity increases as the incident angle becomes smaller, this structure suppresses reflected waves of large power, and thus is effective for suppression of multipath interference.

As described above, the electronic device according to the fifth embodiment prevents noise occurring outside from entering the inside of the shield pipe, with the first ground layer of the first board, the second ground layer of the second board, and the shield pipe, also in the case where the first board is relatively rotated with respect to the second board. In addition, the electronic device also suppresses interference caused by reflection of electromagnetic waves radiated from the antenna arranged on the board, because electromagnetic wave absorbers are arranged on the internal wall of the shield pipe. Accordingly, the electronic device enables suppression of interference of electromagnetic waves with a simple structure.

In each of the above embodiments, at least part of the shield pipe may be formed of an electromagnetic wave absorber, and the other parts of the shield pipe may be formed of a conductor. Specifically, a portion of the shield pipe on which the electromagnetic wave absorber is arranged may not be formed of a conductor, but may be formed of a material that can support the electromagnetic wave absorber. The portion of the shield pipe on which the electromagnetic wave absorber is arranged may not be formed of a conductor, but may be formed of the electromagnetic wave absorber itself. In other words, the shield pipe may be formed of the electromagnetic wave absorber and a conductor that are formed as one unitary piece. Otherwise, the whole shield pipe may be formed of the electromagnetic wave absorber.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions.

The accompanying claims and their equivalents are intended to cover such forms or modifications as would fall within the scope and spirit of the inventions.

What is claimed is:

1. An electronic device comprising:
a first board that has a first surface and a second surface opposed to the first surface, the first board having a first internal layer;
a first ground layer formed on at least one of the first surface and the first internal layer;
a first antenna arranged on at least one of the second surface and a region between the first ground layer and the second surface;
a second board that has a third surface and a fourth surface opposed to the third surface, the second board having a second internal layer, the fourth surface opposed to the second surface;
a second ground layer formed on at least one of the third surface and the second internal layer;
a second antenna arranged on at least one of the fourth surface and a region between the second ground layer and the fourth surface;
a shield pipe arranged between the first board and the second board and formed of a conductor including a first end, a second end, and an internal wall, the first end opposed to the second surface, the second end opposed to the fourth surface; and
an electromagnetic wave absorber arranged on the internal wall,
wherein, when viewed from an axis direction of the shield pipe, an outermost edge of the internal wall at the first end is arranged inside an outermost edge of the first ground layer, the first antenna is arranged inside the outermost edge of the internal wall at the first end, an outermost edge of the internal wall at the second end is arranged inside an outermost edge of the second ground layer, and the second antenna is arranged inside the outermost edge of the internal wall at the second end.

2. The device according to claim 1, further comprising a housing that contains the first board, the second board, and the shield pipe.

3. The device according to claim 1, wherein the shield pipe is electrically connected with at least one of the first ground layer and the second ground layer.

4. The device according to claim 1, wherein
a length of a longest line segment connecting two different points of an edge of the internal wall at the first end is no less than a wavelength of a central frequency in a frequency band used for communication via the first antenna and the second antenna, and
a length of a longest line segment connecting two different points of an edge of the internal wall at the second end is no less than the wavelength.

5. The device according to claim 1, wherein each of a distance between the first end and the first ground layer and a distance between the second end and the second ground layer is shorter than a wavelength of a central frequency in a frequency band used for communication via the first antenna and the second antenna.

6. The device according to claim 1, wherein a space surrounded by the internal wall of the shield pipe, the electromagnetic wave absorber, the first ground layer and the second ground layer includes a first Fresnel zone formed by communication via the first antenna and the second antenna.

7. The device according to claim 1, wherein the electromagnetic wave absorber is arranged on a region of the internal wall of the shield pipe, the region including a midpoint between the first end and the second end.

8. The device according to claim 1, wherein the electromagnetic wave absorber is arranged on a region of the internal wall of the shield pipe, the region covering from the first end to a midpoint between the first end and the second end.

9. The device according to claim 1, wherein the electromagnetic wave absorber is arranged on at least one of the second surface and the fourth surface.

10. The device according to claim 1, further comprising:
a first wireless unit electrically connected with the first antenna and performing signal processing; and
a second wireless unit electrically connected with the second antenna, communicating with the first wireless unit, and performing signal processing.

11. The device according to claim 10, wherein
when viewed from the axis direction of the shield pipe, the first wireless unit is arranged inside the outermost edge of the internal wall at the first end, the second wireless unit is arranged inside the outermost edge of the internal wall at the second end.

12. The device according to claim 1, wherein each of the first antenna and the second antenna is a circularly polarized antenna.

13. The device according to claim 1, wherein the electromagnetic wave absorber is arranged on the internal wall of the shield pipe, and in a first region located in an extending direction of the shield pipe and including a region of the internal wall of the shield pipe that is close to the first antenna.

14. The device according to claim 1, further comprising:
a third antenna arranged in a position different from the first antenna, and arranged on at least one of the second surface and a region between the first ground layer and the second surface;
a third wireless unit electrically connected with the third antenna and performing signal processing;
a fourth antenna arranged in a position different from the second antenna, and arranged on at least one of the fourth surface and a region between the second ground layer and the fourth surface; and
a fourth wireless unit electrically connected with the fourth antenna, communicating with the third wireless unit, and performing signal processing,
wherein, when viewed from the axis direction of the shield pipe, the third antenna is arranged inside the outermost edge of the internal wall at the first end, the fourth antenna is arranged inside the outermost edge of the internal wall of the second end.

15. The device according to claim 14, wherein a space surrounded by the internal wall of the shield pipe, the electromagnetic wave absorber, the first ground layer and the second ground layer includes a first Fresnel zone formed by communication via the third antenna and the fourth antenna.

16. The device according to claim 14, wherein each of the first antenna, the second antenna, the third antenna, and the fourth antenna is a circularly polarized antenna.

17. The device according to claim 14, wherein the electromagnetic wave absorber is arranged on the internal wall of the shield pipe, and in a first region located in an extending direction of the shield pipe and including a region of the internal wall of the shield pipe that is close to the first antenna, and in a second region located in the extending direction of the shield pipe and including a region of the internal wall of the shield pipe that is closed to the third antenna.

18. The device according to claim 1, wherein the first board is relatively rotatable with respect to the second board.

19. An electronic device comprising:
a first board that has a first surface and a second surface opposed to the first surface, the first board having a first internal layer;
a first ground layer formed on at least one of the first surface and the first internal layer;
a first antenna arranged on at least one of the second surface and a region between the first ground layer and the second surface;
a second board that has a third surface and a fourth surface opposed to the third surface, the second board having a second internal layer, the fourth surface opposed to the second surface;
a second ground layer formed on at least one of the third surface and the second internal layer;
a second antenna arranged on at least one of the fourth surface and a region between the second ground layer and the fourth surface; and
a shield pipe arranged between the first board and the second board and including a first end, a second end, and an internal wall, the first end opposed to the second surface, the second end opposed to the fourth surface, at least part of the internal wall being formed of an electromagnetic wave absorber, and parts other than the at least part are formed of a conductor,
wherein, when viewed from an axis direction of the shield pipe, an outermost edge of the internal wall at the first end is arranged inside an outermost edge of the first ground layer, the first antenna is arranged inside the outermost edge of the internal wall at the first end, an outermost edge of the internal wall at the second end is arranged inside an outermost edge of the second ground layer, and the second antenna is arranged inside the outermost edge of the internal wall at the second end.

20. The device according to claim 19, wherein the whole shield pipe is formed of the electromagnetic wave absorber.
